(19) United States
(12) Patent Application Publication
(10) Pub. No.: US 2024/0217778 A1
(43) Pub. Date: Jul. 4, 2024

(54) ROTARY POWER TRANSFER SYSTEM FOR LINEAR MOTOR ELEVATORS

(71) Applicants: DESIRD TASARIM ARGE ANONIM SIRKETI, Muratpasa, Antalya (TR); LINEARITY CO., LTD., Kyoto (JP)

(72) Inventors: Sandor Andras MARKON, Kyoto (JP); Ahmet ONAT, Istanbul (TR); Ender KAZAN, Muratpasa, Antalya (TR)

(21) Appl. No.: 18/556,766

(22) PCT Filed: Dec. 28, 2021
(86) PCT No.: PCT/TR2021/051566

§ 371 Date: Oct. 23, 2023

(51) Int. Cl. B66B 11/04; H02K 41/03

(52) U.S. Cl. CPC B66B 11/0407; H02K 41/031

(57) ABSTRACT

A rotary power transfer system for a linear motor elevator having at least one rotor with magnetic poles facing the stator coils and attached to the elevator cabin, at least one generator or secondary coil set connected to the rotor, and an excitation algorithm providing traveling excitation current to the sections of the linear motor stator facing the rotor.

### TECHNICAL FIELD

The invention relates to the general field of elevator electrical engineering and has certain specific application to rope-less linear motor elevators. Power transfer system described in the invention provides low-cost and reliable power transfer for rope-less linear motor elevators. It may be used by single-car or multi-car linear motor elevators operating on linear, curved or branching trajectories.

### PRIOR ART

Rope-less linear motor elevators, being self-propelled, offer various benefits such as the capability of operating several elevator cabins independently in the same hoistway, and potentially operating in curved travel paths. On the other hand, the traditional method of supplying power through wired connections in the “traveling cable” is no longer available, and suitable methods must be developed to supply the power needed for lighting, ventilation, door operation etc. in the cabin.

A commonly used wireless power transfer method uses electromagnetic connection between coils and/or wire loops installed on the elevator cabin and on the hoistway side. The connection is typically achieved by a high-frequency excitation, on the order of 100 kHz or higher, and the coupling is made efficient by resonance. Although this method can provide the required electric power transfer, it has the disadvantage that the hoistway-side coils that span the full length of the hoistway are separate devices, thus requiring high initial costs and maintenance costs, while also increasing the number of potential failure points.

Instead of providing separate devices for electromagnetic field generation, it would be advantageous to use the already available coils of the linear motor stator. However, unfortunately it is not feasible to directly couple secondary coils to the stator coils:
In case of the high-frequency electromagnetic coupling, such as common with resonant power transfer, the solid wires of the stator coils have very high effective resistance because of the skin effect, making power transfer impractical. It would be necessary to use Litze wire for the stator, but this is not practically feasible for cost, strength and other considerations.
In case of low frequencies like those used for motor operation, a transformer formed by the stator coils and secondary coils on the cabin would have very high transfer impedance due to the high effective air gap, thus again making power transfer impractical. Forming an effective transformer would require iron cores, which are not preferable for a linear motor elevator due to cost, cogging torque, attractive force and other issues.

The abstract of a prior art patent application with the publication number U.S. Ser. No. 10/531,256B2 is as follows; “An elevator system includes an elevator car disposed in and arranged to move along a hoistway. A linear propulsion system of the elevator system is constructed and arranged to propel the elevator car, and includes a plurality of primary coils engaged to and distributed along the hoistway generally defined by a stationary structure. A wireless power transfer system of the elevator system is configured to inductively transfer power to the elevator car. The wireless power transfer system includes a secondary coil mounted to the elevator car and is configured to be induced with electromotive forces by the primary coils and output power for use by the elevator car. A communication system of the elevator system is configured to utilize the secondary coil and the plurality of primary coils to exchange a communication data signal.”

As can be seen, this prior art document cannot provide a solution to the above-mentioned disadvantages.

As a result, due to the above-mentioned disadvantages and the inadequacy of the existing solutions, an improvement in the relevant technical field was required.

### PURPOSE OF THE INVENTION

The invention aims to provide a method with different technical characteristics which brings a new perspective in this field, unlike the embodiments used in the present art.

Main purpose of the invention, providing a low-cost and reliable power transfer solution to linear motor elevators using the stator coils as part of the system.

A system for rotary power transfer for linear motor elevators is disclosed. The system is capable of practical power transfer to the elevator cabin by re-using the existing linear motor stator coils for the secondary purpose of power transfer. The disclosed system provides safe and reliable power transfer for single-car or multi-car linear motor elevators.

In order to fulfill the above-described purposes, the invention is a rotary power transfer system for linear motor elevator, characterized by comprising;
at least one rotor with magnetic poles facing the stator coils and attached to the elevator cabin,
at least one generator or secondary coil set connected to the rotor,
an excitation algorithm providing traveling excitation current to the sections of the linear motor stator facing the rotor.

The structural and characteristic features and all advantages of the invention will become more apparent from the following figures and the detailed description made with reference to these figures, and therefore the evaluation should be made with reference to these figures and detailed description.

### BRIEF DESCRIPTION OF THE FIGURES

FIG. 1 illustrates an overview of part of a preferred embodiment, with a generator connected to the rotor.

FIG. 2 illustrates an extended embodiment, with two rotors facing each other across the linear motor stator coil.

FIG. 3 illustrates an overview of part of another preferred embodiment, with a secondary coil set surrounding the rotor.

The drawings do not necessarily have to be scaled and details which are not necessary to understand the present invention may be omitted. Furthermore, elements which are at least substantially identical or at least substantially identical functions are designated by the same number.

### REFERENCE LIST

1. Stator coils
2. Rotor
3. Generator
4. Secondary rotor
5. Secondary coils
6. Mover
7. Magnet
8. Magnetic flux
9. Rotation

### DETAILED DESCRIPTION OF THE INVENTION

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

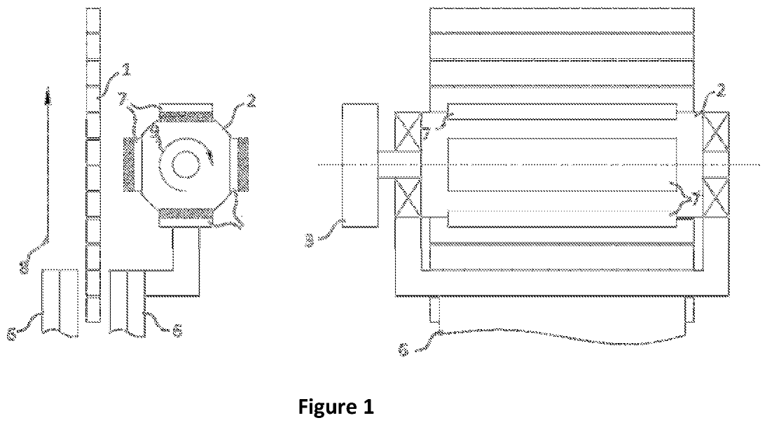

FIG. 1—Rotor (2) with connected generator (3) facing the stator. FIG. 1 illustrates an overview of the preferred embodiment. It shows a cross sectional view of the stator coils (1) and the rotor (2), and a front view of the rotor (2) facing the stator, with the generator (3) attached to its axis.

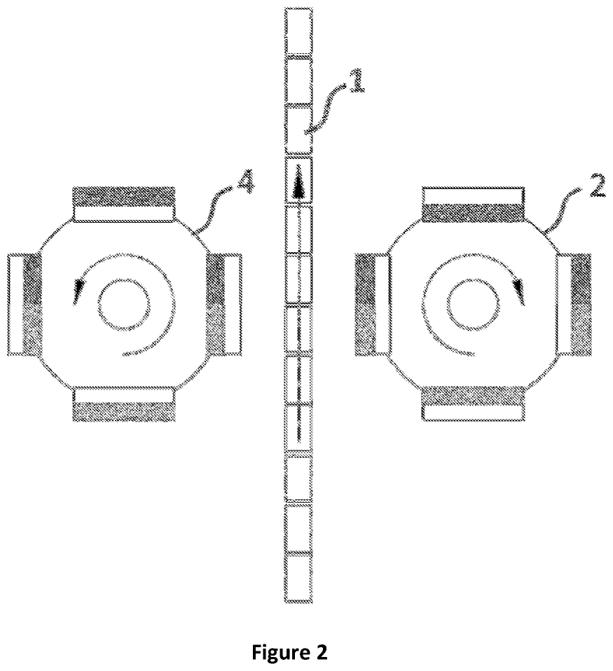

FIG. 2—Two rotors (2) with connected generators (3) across the stator. FIG. 2 illustrates an overview of another preferred embodiment. It shows a cross sectional view of the stator coils (1) and two rotors (2) facing each other across the stator.

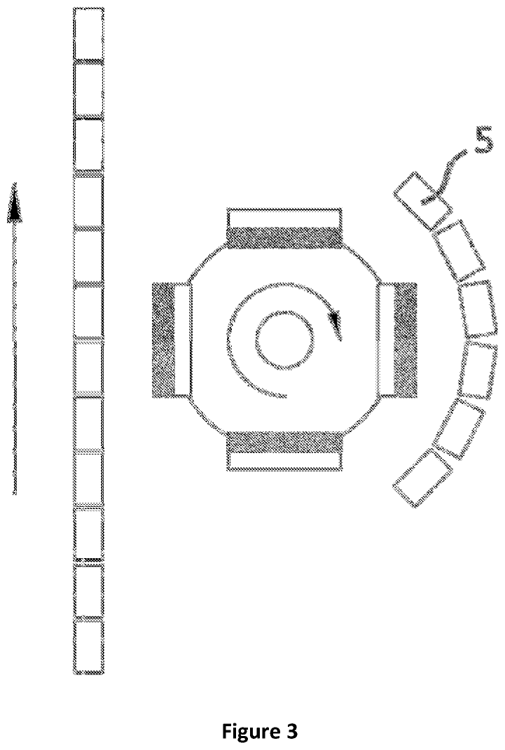

FIG. 3—Rotors (2) with secondary coils (1). FIG. 3 illustrates an overview of yet another preferred embodiment. It shows a cross sectional view of the stator coils (1), a rotor (2), and a set of secondary coils (5).

The rotary power transfer system which is the subject of the invention is used in a rope-less single-car or multi-car linear motor elevator systems which have a linear motor drive system and one or more elevator cabins. The term “linear motor elevator drive” collectively defines the stator or multiple stators, and the mover or multiple movers, together capable of holding and moving an elevator cabin or a multiplicity of elevator cabins.

3-phase excitation currents in the stator coils (1) generate a traveling magnetic field that is capable of driving a magnetic rotor (2). The rotor (2) with alternating magnetic poles is placed facing the stator coils (1), and rotates in synchronicity with the traveling magnetic field. The rotor (2) is mounted on the linear motor mover (6) and travels with it. A generator (3), typically a 3-phase permanent magnet synchronous generator, is mounted on the shaft of the rotor (2), and generates the output electric power. A secondary rotor (4), typically identical to the rotor (2), is placed on the other side of the stator coils (1), in order to close the magnetic flux (8) path and increase the magnetic field strength inside the stator coils (1). A set of secondary coils (5) placed near and preferably around the rotor (2), and allows the rotor (2) to serve in two roles: first, as a synchronous motor rotor (2) together with the stator coils (1); and second, as a synchronous generator rotor (2), together with the secondary coils (5).

The linear motor stator coils (1) are arranged in sections, each to be driven independently by 3-phase inverters. With this arrangement, those stator coils (1) which are not involved in force generation with the mover (6), i.e., which do not face the mover (6), are available for the secondary role of driving the rotor (2). During operation of the linear motor, as the mover (6) moves along the stator, stator coils (1) become available behind the mover (6). When stator coils (1) are driven by a 3-phase current with a rotating phase vector, the generated traveling magnetic field interacts with the magnets (7) of the rotor (2) or the combined magnets (7) of rotor (2) and secondary rotor (4), causing it or them to rotate in synchronicity. Rotor's (2) direction of rotation (9) can be changed if direction of magnetic flux (8) changes. The generator (3) attached to rotor (2) will also rotate, and generate a voltage and in case of a finite load, also a current. This voltage and current is available for use at the mover (6) side, as a contactless transmitted power. On the other hand, while rotor (2) and secondary rotor (4) are rotating, voltage and current are induced across the terminals of secondary coils (5). In this way, extra power transfer is provided.

Rotor (2) is broadly defined to include any kind of rotating or circulating device equipped with magnetic poles, capable of interacting with the traveling magnetic field of the linear motor stator coils (1). The pole pitch of the magnetic poles of the rotor (2) is set approximately equal to the pole pitch of the linear motor stator, or to some multiple of that.

Generator (3) is an electrical generator connected to the axis of the rotor (2), operating as a synchronous generator, DC generator, asynchronous generator, or similar suitable device for converting rotating motion into electrical energy.

Secondary coils (5) set is an electrical generator (3) operating as a synchronous generator, excited by the rotating magnetic field of the rotor (2).

The rotor (2) or multiple rotors (2) are installed at the linear motor mover (6) that carries the elevator cabin with their axis of rotation (9) parallel to the linear motor stator coils (1), and their surface at a close distance to the stator coil surface.

During operation, when it is necessary to generate power for the elevator cabin, the linear motor stator coils (1) that are facing the rotor (2), are energized with a 3-phase current, in order to generate a traveling magnetic field along the stator. This traveling field interacts with the magnetic poles of the rotor (2), causing it to rotate. The rotation (9) drives the generator (3) and it generates electric power, that becomes available for the elevator cabin.

When the linear motor mover (6) is stationary, thus the rotor (2) is at a constant position with respect to the stator, excitation will be in the stator coils (1) facing the rotor (2). When the linear motor mover (6) is moving, the stator coils (1) facing the rotor (2) will be changing and the excitation will need to follow the movement of the rotor (2) along the stator.

Since the rotor (2) operates as a synchronous motor, it is necessary to synchronize the phase of the excitation with the phase angle of the rotor (2). If there is only a small torque acting on the rotor (2) from the generator (3), the synchronicity can be automatically achieved by the magnetic torque acting between the stator and rotor (2). However, in general it is necessary to provide a means of synchronizing the stator current to the rotor (2) angle. One easy way to achieve this is to use a sensorless vector control algorithm, such as common in the ESC (Electronic Speed Controller) inverters used in RC (Radio Control) model cars or drones.

The generated voltage will be proportional to the rotating speed of the rotor (2), which is in turn proportional to the frequency of the stator excitation. This frequency can be set according to the required power transfer, increasing it when more power is required. During the movement of the linear motor mover (6), the rotor (2) speed will be determined by the difference of the linear running speed and the excitation frequency. This will need to be taken into account when controlling the excitation frequency to set the transferred power.

In general, it is preferable to use a rotor (2) with a low number of poles. One reason is to allow relatively high rotational speed with relatively low excitation frequency. Another reason is that those magnetic poles are active in coupling the stator magnetic field to the rotor (2) that are directly facing the stator; if the diameter of the rotor (2) and its pole count is high, there will be many poles facing away from the stator and thus not contributing to the operation.

To improve the magnetic path of the rotor (2) magnet poles, it is advantageous to install two rotors (2) across the stator coil (1) as shown in FIG. 2. This will increase the magnetic field intensity across the stator and thus provide higher torque with the same stator currents. Further arrangements might use four rotors (2), two in tandem at each side (not shown in the Figures), to provide a still lower magnetic resistance to the magnetic field.

Other magnetic pole arrangements are also possible, for instance by using a rotor axis perpendicular to the stator surface to achieve a rotor (2) magnet movement parallel to the stator surface. Such variations are easily designed by engineers familiar with the operation of linear and rotating motors and thus they are within the scope of the current invention.

In case the generator (3) is a 3-phase synchronous generator, its generated AC voltage will typically be rectified, and the resulting DC voltage will be regulated by feeding it to a DC/DC converter. The resulting voltage will be used to drive the equipments on the cabin. A wireless signal can be transferred from the cabin to the stator side to inform the stator controller about the generated voltage; if necessary, the stator controller will control the excitation of the stator coils (1) to increase or decrease the rotor (2) speed.

The disclosed embodiments are illustrative, not restrictive. While specific configurations of the rotary power transfer system have been described, it is understood that the present invention can be applied to a wide variety of elevator systems. There are many alternative ways of implementing the invention, including but not limited to having different arrangements for the rotor (2). The invention is also suitable for non-linear (curved) movement paths of the linear motor elevator, or for movements along branching paths with switches.

1. A rotary power transfer system for linear motor elevator, the system comprising:
at least one rotor with magnetic poles facing stator coils and attached to an elevator cabin;
at least one generator or secondary coil set connected to the rotor; and
an excitation algorithm providing traveling excitation current to sections of the linear motor stator facing the rotor.

2. The rotary power transfer system according to claim 1, wherein:
multiple elevator cabins are installed in the same hoistway;
each of elevator cabins are equipped with rotary power transfer equipment; and
each of the rotary power transfer equipments are arranged to be driven by the same stator coil.

3. The rotary power transfer system according to claim 1, wherein a secondary rotor, typically identical to the rotor, is placed on the other side of the stator coils, in order to close a magnetic flux path and increase a magnetic field strength inside the stator coils.

4. The rotary power transfer system which is used in a rope-less linear motor elevator system according to claim 1, comprising:
a linear motor drive system; and
an elevator cabin.

5. The rotary power transfer system which is used in a rope-less multi-car linear motor elevator system according to claim 1, comprising:
a linear motor drive system; and
a plurality of elevator cabins.
